(19) United States
(12) Patent Application Publication
(10) Pub. No.: US 2025/0023840 A1
(43) Pub. Date: Jan. 16, 2025

(54) METHOD, DEVICE, COMPUTER PROGRAM AND RECORDING MEDIUM FOR PROVIDING INTERACTIVE COMMUNICATION SERVICE THROUGH DYNAMIC MODE SWITCHING

(71) Applicant: Bemyfriends, Inc., Seoul (KR)

(72) Inventors: Junki KIM, Gyeonggi-do (KR); Haanee NAM, Seoul (KR); Yoojin JEONG, Seoul (KR); Jinkwon LEE, Gyeonggi-do (KR); Taeuk KIM, Gyeonggi-do (KR); Jihyun PARK, Gyeonggi-do (KR)

(21) Appl. No.: 18/771,974

(22) Filed: Jul. 12, 2024

(30) Foreign Application Priority Data
Jul. 14, 2023 (KR) 10-2023-0091850
Aug. 17, 2023 (KR) 10-2023-0107644

(51) Int. Cl. H04L 51/42; G06F 3/04815; G06F 9/451

(52) U.S. Cl. CPC H04L 51/42; G06F 3/04815; G06F 9/451

(57) ABSTRACT

A method for dynamically switching modes, performed by a first device used by a first user may include displaying a first layer including a first content user interface (UI) based on a first mode and a second layer including a first control UI capable of controlling at least one operation associated with the first mode, the second layer including a first chat UI for exchanging messages with other users; based on a mode of the first layer switching from the first mode to a second mode, switching from the first control UI to a second control UI capable of controlling at least one operation associated with the second mode on the second layer and maintaining the first chat UI.

### CROSS-REFERENCE TO RELATED APPLICATIONS

This application claims the benefit of earlier filing date and right of priority to Korean Application No. 10-2023-0091850, filed on Jul. 14, 2023, Korean Application No. 10-2023-0107644, filed on Aug. 17, 2023, the contents of which are all hereby incorporated by reference herein in their entirety.

### TECHNICAL FIELD

The present disclosure relates to a method, device, computer program, and recording medium for providing a bidirectional communication service, and more particularly, to a method, device, computer program, and recording medium that provides bidirectional communication services through dynamic mode switching.

### BACKGROUND

As information and communication technology develops, social network service (SNS)-related technologies that enable free communication between individuals on the Internet are also continuously being developed and utilized, and the resulting social ripple effect is also growing.

Additionally, SNS has become an essential means of promotion and communication in the entertainment industry. Artists are effectively promoting their content and communicating with fans through SNS, and fans are also using SNS as a community where they can share and communicate about content produced by artists.

Recently, various services that enable two-way communication between artists and fans have been released. For example, while an artist is broadcasting live, various services are continuously being released that allow fans to send messages to the artist through a chat window.

However, in the past, technologies and services that efficiently convert and provide bidirectional communication service modes between artists and fans have not been introduced, and demand and expectations for them are growing.

### SUMMARY

The technical problem of the present disclosure is to provide a method, device, computer program, and recording medium for providing a bidirectional communication service through dynamic mode switching.

In addition, the technical problem of the present disclosure is to provide a method, device, computer program, and recording medium thereof that allow artists and fans to communicate by dynamically switching modes within a single chat room.

The technical problems to be achieved in the present disclosure are not limited to the technical tasks mentioned above, and other technical problems not mentioned will be clearly understood by those skilled in the art from the description below.

According to one embodiment of the present disclosure, a method for dynamically switching modes, performed by a first device used by a first user may include displaying a first layer including a first content user interface (UI) based on a first mode and a second layer including a first control UI capable of controlling at least one operation associated with the first mode, the second layer including a first chat UI for exchanging messages with other users; based on a mode of the first layer switching from the first mode to a second mode, switching from the first control UI to a second control UI capable of controlling at least one operation associated with the second mode on the second layer and maintaining the first chat UI, and a content associated with the mode of the first layer corresponding to an input by a second device may be output on the first content UI, and the second layer may include a personal page UI of the first user based on the content associated with the mode of the first layer.

In addition, all or part of the first content associated with the first mode output on the first content UI through the first control UI may be extracted, and a second content generated based on all or part of the extracted first content may be output on the personal page UI.

In addition, based on a mode of the first layer being a mode for providing streaming video, a content associated with the mode of the first layer may include a live streaming video input to the second device.

In addition, based on a mode of the first layer being a mode for private message exchange, a content associated with the mode of the first layer may include at least one of text, image, or video input to the second device, and at least one of the text, image, or video input to the second device may be generated based on information of the first user.

In addition, the first layer may further include a second chat UI, and a text, image or video entered into at least one of the first chat UI or the second chat UI on the second layer may be input to the artificial intelligence (AI) model and a score indicating inappropriateness corresponding to the text, image or video may be output, and based on the score exceeding a threshold, the text, image, or video may be transmitted to a third device used by an administrator.

In addition, the second layer may include a third chat UI created by the first user, and based on an identifier corresponding to the second device being added to a participant list on the third chat UI, at least one of a message or indicator indicating participation of the identifier corresponding to the second device may be displayed on the third chat UI.

In other words, based on an event occurring in which an identifier corresponding to the second device is added to the third chat UI, the device may display at least one of a message or indicator indicating participation of an identifier corresponding to the second device on the third chat UI or/and an icon for participating in the third chat UI.

In addition, a rating of the first user may be determined based on the first user's activity history in at least one of the first layer or the second layer, and a non-fungible token (NFT) may be generated based on a quick response (QR) code to which identification information indicating the rating of the first user is mapped or information on the first user including the rating of the first user.

In addition, the second device may be controlled by an artist or an administrator associated with the artist, and a 3-dimension (3D) avatar representing the first user, digital goods related to the artist, or the second content may be included in the personal page UI composed of a 3D virtual space.

In addition, the digital goods related to the artist may be purchased through rewards based on the first user's activity history in at least one of the first layer or the second layer.

According to one embodiment of the present disclosure, the first device performing a method of dynamically switching modes may include at least one transceiver; at least one memory; and at least one processor; and the at least one processor may be configured to: display a first layer including a first content user interface (UI) based on a first mode and a second layer including a first control UI capable of controlling at least one operation associated with the first mode, the second layer including a first chat UI for exchanging messages with other users; based on a mode of the first layer switching from the first mode to a second mode, switch from the first control UI to a second control UI capable of controlling at least one operation associated with the second mode on the second layer and maintain the first chat UI, and a content associated with the mode of the first layer corresponding to an input by a second device may be output on the first content UI, and the second layer may include a personal page UI of the first user based on the content associated with the mode of the first layer.

According to one embodiment of the present disclosure, a method for dynamically switching modes, performed by a second device may include displaying a first layer including a first content user interface (UI) based on a first mode and a third layer for switching a mode of the first layer; inputting content related to the first mode on the first content UI; and based on a mode of the first layer being switched from the first mode to a second mode through the third layer, switching from the first content UI to a second content UI for inputting content related to the second mode, and a content associated with the first mode may be output on the first content UI displayed on a first device.

In addition, the first layer may further include a second chat UI, a text, image or video input to the second chat UI is input to an artificial intelligence (AI) model and a score indicating inappropriateness corresponding to the text, image or video is output, and based on the score exceeding a threshold, the text, image, or video may be transmitted to a third device used by an administrator.

In addition, at least one digital good may be generated based on a content associated with the first mode output through the first content UI or a content associated with the second mode output through the second content UI.

In addition, based on an identifier corresponding to the first user being selected among a plurality of users included in a participant list on the second chat UI, a second layer including a personal page UI of the first user may be displayed.

In addition, based on the first mode being a mode for private message exchange, a content associated with the first mode may include at least one of text, image, or video including at least one identifier, at least one of a text, image, or video including the at least one identifier may be output to the first content UI of devices used by a plurality of users, and the at least one identifier may be converted based on information about the plurality of users.

According to one embodiment of the present disclosure, a second device performing a method of dynamically switching modes may include at least one transceiver; at least one memory; and at least one processor; wherein the at least one processor is configured to: display a first layer including a first content user interface (UI) based on a first mode and a third layer for switching a mode of the first layer; inputting content related to the first mode on the first content UI; and based on a mode of the first layer being switched from the first mode to a second mode through the third layer, switch from the first content UI to a second content UI for inputting content related to the second mode, and a content associated with the first mode may be output on the first content UI displayed on a first device.

The features briefly summarized above with respect to the disclosure are merely exemplary aspects of the detailed description of the disclosure that follows, and do not limit the scope of the disclosure.

According to various embodiments of the present disclosure, a method, an apparatus, a computer program, and a recording medium thereof that provide a bidirectional communication service through dynamic mode switching can be provided.

According to various embodiments of the present disclosure, a method, device, computer program, and recording medium for providing a bidirectional communication service through dynamic mode switching may be provided.

According to various embodiments of the present disclosure, a method, device, and computer program can be provided that can dynamically switch a mode for bidirectional communication between artists and fans based on a single layer structure.

According to various embodiments of the present disclosure, by diversifying the types of content that can be output from each layer, the efficiency and convenience of communication between artists and fans can be improved as services expand.

The effects obtainable in the present disclosure are not limited to the effects mentioned above, and other effects not mentioned will be clearly understood by those skilled in the art from the description below.

### BRIEF DESCRIPTION OF THE DRAWINGS

FIG. 1 is a flowchart illustrating a method of dynamically switching a mode of a layer for a bidirectional communication service performed by a first device, according to an embodiment of the present disclosure.

FIG. 2 is a flowchart showing a method of dynamically switching the mode of a layer for a bidirectional communication service performed by a second device, according to an embodiment of the present disclosure.

FIG. 3 is a block diagram conceptually showing a first device and/or a second device according to an embodiment of the present disclosure.

FIGS. 4A, FIG. 4B, FIGS. 5A and 5B are diagrams for describing a layer structure and conversion procedure according to an embodiment of the present disclosure.

### DETAILED DESCRIPTION

Hereinafter, with reference to the attached drawings, embodiments of the present disclosure will be described in detail so that those skilled in the art can easily practice them. However, the present disclosure may be implemented in many different forms and is not limited to the embodiments described herein.

In describing embodiments of the present disclosure, if it is determined that detailed descriptions of known configurations or functions may obscure the gist of the present disclosure, detailed descriptions thereof will be omitted. In addition, in the drawings, parts that are not related to the description of the present disclosure are omitted, and similar parts are given similar reference numerals.

In the present disclosure, when a component is said to be “connected”, “coupled” or “connected” to another component, this may include not only a direct connection relationship, but also an indirect connection relationship where another component exists in between. In addition, when a component is said to “include” or “have” another component, this does not mean excluding the other component, but may further include another component, unless specifically stated to the contrary.

In the present disclosure, terms such as first, second, etc. are used only for the purpose of distinguishing one component from another component, and do not limit the order or importance of the components unless specifically mentioned. Accordingly, within the scope of the present disclosure, a first component in one embodiment may be referred to as a second component in another embodiment, and similarly, the second component in one embodiment may be referred to as the first component in another embodiment.

In the present disclosure, distinct components are intended to clearly explain each feature, and do not necessarily mean that the components are separated. That is, a plurality of components may be integrated to form one hardware or software unit, or one component may be distributed to form a plurality of hardware or software units. Accordingly, even if not specifically mentioned, such integrated or distributed embodiments are also included in the scope of the present disclosure.

In the present disclosure, components described in various embodiments do not necessarily mean essential components, and some may be optional components. Accordingly, embodiments consisting of a subset of the elements described in one embodiment are also included in the scope of the present disclosure. Additionally, embodiments that include other components in addition to the components described in the various embodiments are also included in the scope of the present disclosure.

The definitions of terms used in the present disclosure are as follows.

“Artist” refers to entities that produce and provide various contents (e.g., music, movies, performances, etc.).

“User” refers to a subject who consumes various contents provided by an artist, and may mean a fan of the artist.

“Layer” may refer to a unit area that constitutes the entire screen of an application (i.e., the entire display area of the application) that allows bidirectional communication between one or more artists and multiple users.

As an example, the entire application screen may be composed of at least one of a first layer related to the artist, a second layer related to the user, or a third layer related to changing the mode of the first layer and/or the second layer.

“User interface” may refer to a unit area divided by function. As an example, each layer may include one or more UIs differentiated for each function. A UI related to a specific function may include an icon that can control the specific function and/or content related to the specific function.

“Mode” may refer to a type of bidirectional communication service between artists and users.

For example, “mode” may include, but is not limited to, live host mode (e.g. a mode where an artist can play a live stream), live participant mode (e.g., a mode that displays a conversation window between fans), star chat mode (e.g., a mode for private messaging service between artists and users), etc.

That is, in describing the present disclosure, each of the first mode and the second mode may be at least one of a live host mode, a live participant mode, or a star chat mode, but is not limited thereto.

“System” may refer to a system that includes one or more devices (e.g., a first device used by the first user, a second device used by the second user, and/or a third device used by the administrator) to perform a method for enhancing the real-time communication environment between artists and fans by dynamically switching various modes related to the bidirectional communication service.

The present disclosure relates to a method and device for enhancing a real-time communication environment between artists and fans by dynamically switching various modes related to a bidirectional communication service.

According to one embodiment of the present disclosure, an application that can perform bidirectional communication between one or more artists and a plurality of users (or a single chat room provided through the application) may be composed of one or more layers.

Each layer includes one or more UIs to provide bidirectional communication services, and the mode of the layer to provide content can be changed/converted in real time by the artist. Here, chat history between multiple users and/or chatting between multiple users and artists may be maintained as is.

Additionally, among the chat history between a plurality of users and an artist, messages input from the artist may be distinguished from messages input from other users. In other words, the artist's message may be displayed or edited to distinguish it from other messages.

Additionally, the user can extract content provided on the layer controlled by the artist. That is, the user can extract all or part of the content provided by the artist, and store and/or process the extracted content (that is, create new content by editing the extracted content).

Accordingly, it is possible to overcome the structural and expressive limitations of communication between fans and artists in a single mode generally provided.

Hereinafter, the present disclosure will be described in more detail with reference to the drawings.

In describing the present disclosure, the operation of exchanging messages and/or content between devices may include at least one of the following: i) directly exchanging messages and/or content between devices and ii) exchanging messages and/or content input by each device via a server.

Here, the server collectively refers to one or more devices that manage and control an application that allows the bidirectional communication between one or more artists and a plurality of users.

That is, the server may store and manage information related to one or more artists and multiple users (e.g., information when more than one artist and multiple users register for the application), information about content input by one or more artists and multiple users, etc.

Additionally, the server may include an artificial intelligence (AI) model, which has been learned to determine whether the text, image and image are inappropriate between one or more artists and a plurality of users. The device used by the administrator may determine whether text, images, and videos exchanged between one or more artists and multiple users are appropriate through an AI model included in the server.

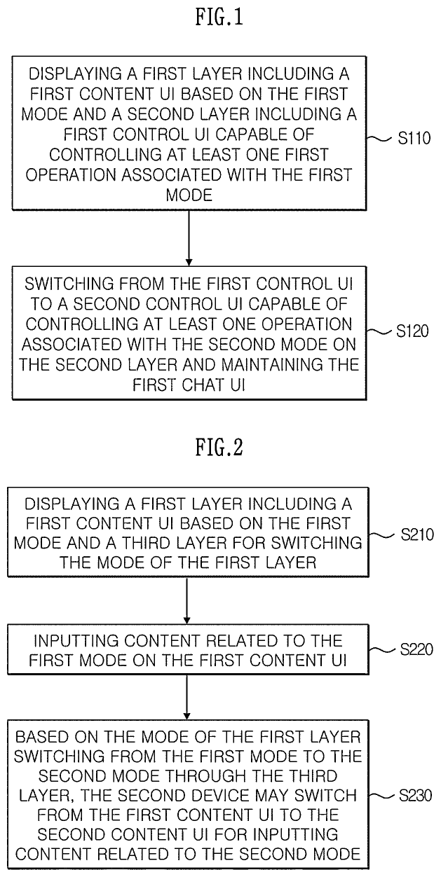

FIG. 1 is a flowchart showing a method of dynamically switching the mode of a layer for a bidirectional communication service, according to an embodiment of the present disclosure.

Specifically, a method for dynamically switching the mode of a layer for a bidirectional communication service performed by a first device used by a user will be described with reference to FIG. 1.

A first device used by the user in step S110 may display a first layer including a first content UI based on the first mode and a second layer including a first control UI capable of controlling at least one first operation associated with the first mode.

Here, the content associated with the mode of the first layer may be provided to the user by displaying content corresponding to an input by a second device used by an artist and/or a person in charge related to the artist on the first content UI. That is, the second device used by the artist may input and provide content related to the first mode displayed on the first content UI based on the first mode of the first device.

As an example, content input/generated through a second device may be transmitted to a server. The server may transmit the content received from the second device to the device used by a plurality of users so that the content is output on the first content UI of the device (e.g., the first device) used by the plurality of users.

Additionally or alternatively, the first layer including the first content UI may also be displayed on the second device. And, the second device may input content on the first content UI. The first device may receive content input by the second device through the first content UI.

As an example, similar to the method described above, content input by the second device on the first content UI may be played/output on the first content UI of the first device through the server. As another example, a second device and a plurality of devices may be connected through various communication methods. Content input by the second device on the first content UI may be directly transmitted to the first device through the corresponding communication method.

The first at least one action associated with the first mode refers to an action for interacting with content and/or artists associated with the first mode provided by a second device. That is, the first device may control operations for interacting with content and/or artists related to the first mode provided by the second device through the first control UI.

And, the second layer may further include a first chat UI. The first device may display messages exchanged between other users through the first chat UI. That is, while the artist provides content through the first content UI included in the first layer, a plurality of users may exchange messages with each other through the first chat UI included in the second layer.

Additionally, a plurality of users can perform operations to interact with content provided by the artist through the first control UI. Additionally or alternatively, the first chat UI may include a history of messages exchanged between a plurality of users and the artist.

As an example of the present disclosure, content corresponding to an input from a second device used by an artist or content input through a first content UI displayed on the second device may be directly transmitted to devices used by users. Accordingly, content directly input may be displayed on the first content UI of the device used by users.

Additionally or alternatively, content corresponding to the input of the second device used by the artist or content input through the first content UI displayed on the second device may be transmitted to the server. The server may transmit the input content to the devices used by each user. Accordingly, devices used by users may display/output content received from the server on the first content UI.

As another example of the present disclosure, a message entered by a user on a first device may be directly transmitted to a device used by another user. A device used by another user may display the received message on the first chat UI.

Additionally or alternatively, messages entered by the user on the first device may be transmitted to the server. The server may transmit the entered message to devices used by other users. Accordingly, devices used by other users may display messages received from the server on the first chat UI.

Based on the mode of the first layer switching from the first mode to the second mode in step S120, the first device may switch from the first control UI to a second control UI that can control at least one operation associated with the second mode and maintain the first chat UI on the second layer.

As an example of the present disclosure, the second device may switch the mode of the first layer from the first mode to the second mode. As an example, the second device may change and control the mode of the first layer through the third layer. The third layer may be included in the first layer, or may be placed in an area below or above the first layer. That is, the position of the third layer can be freely changed by the second device.

As the mode of the first layer switches from the first mode to the second mode, the first control UI may be converted to a second control UI that can control at least one operation associated with the second mode (i.e., an operation for interacting with content and/or an artist associated with the second mode). And, the first content UI may be converted to a second content UI for outputting content related to the second mode.

Here, the first chat UI (or chat history exchanged between a plurality of users and/or artists on the first chat UI) and/or personal page UI may be maintained on the second layer. Accordingly, the user can maintain the chat history exchanged with other users and/or artists even if the mode of the first layer is changed.

Additionally or alternatively, maintaining the first chat UI may mean maintaining chat history exchanged through the first chat UI. That is, the form and/or structure of the first chat UI on the second layer changes according to the mode conversion of the first layer, and the chat history exchanged through the first chat UI can be maintained.

As an example, when the mode of the first layer switches from a text-based chat mode (e.g., star chat mode) to a live streaming mode (e.g., live host mode), the first chat UI may be changed from a text-based chat UI structure to a chat UI structure corresponding to live streaming.

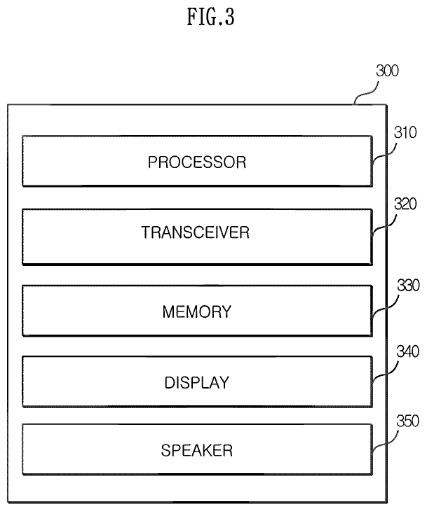

FIG. 2 is a flowchart showing a method of dynamically switching the mode of a layer for a bidirectional communication service, according to an embodiment of the present disclosure.

Specifically, with reference to FIG. 2, a method for dynamically switching the mode of a layer for a bidirectional communication service performed by a second device used by a user will be described.

The second device may display a first layer including a first content UI based on the first mode and a third layer for switching the mode of the first layer (S210). Here, the third layer may include a mode switching UI that can switch the mode of the first layer. The mode switching UI may include icons for selecting multiple modes.

For example, if the icon corresponding to the first mode is selected while the first content UI based on the first mode is displayed on the first layer, the device may switch the mode of the first layer from the first mode to the second mode.

The second device may input content related to the first mode on the first content UI (S220).

An artist using the second device and/or a person in charge related to the artist may input content related to the first mode on the first content UI. The first content UI may include at least one icon that can control functions necessary for inputting content related to the first mode. An environment in which the artist and/or the person in charge related to the artist can input content related to the first mode on the first content UI may be set by selecting at least one icon.

As described above, content related to the first mode input on the first content UI of the second device may be transmitted to terminal devices used by a plurality of users through a server. However, this is only an example, and the second device may directly transmit content related to the first mode input on the first content UI to terminal devices used by a plurality of users.

Content associated with the first mode may be output on the first content UI displayed on the first device. The first device used by the first user among the plurality of users may output content related to the received first mode on the first content UI.

As an example of the present disclosure, based on the first mode being a mode for private message exchange, content associated with the first mode may include at least one of text, image, or video including at least one identifier.

At least one of text, image, or video including at least one identifier may be output from the first content UI of the device used by multiple users. Here, at least one identifier may be converted based on information about a plurality of users (e.g., names, nicknames, etc. of the plurality of users).

That is, as at least one identifier is converted into the user's name in a text including at least one identifier, the user can feel the feeling of directly communicating with the artist.

Based on the mode of the first layer switching from the first mode to the second mode through the third layer, the second device may switch from the first content UI to the second content UI for inputting content related to the second mode (S230).

That is, based on the second mode being selected through the mode switching UI included in the third layer, the device may switch the first content UI to the second content UI. The second content UI may include at least one icon that can control functions necessary for inputting content related to the second mode.

Additionally or alternatively, the second device may generate one or more digital goods (e.g., emoticons, stickers, online/offline concert participation tickets, etc.) based on content associated with the first mode output through the first content UI or content associated with the second mode output through the second content UI.

As an example, the second device may extract an artist's image from a streaming video output through the first content UI. The second device may create an emoticon or sticker based on the extracted image of the artist. A plurality of users can purchase digital goods created by the second device using rewards obtained based on activity history, etc.

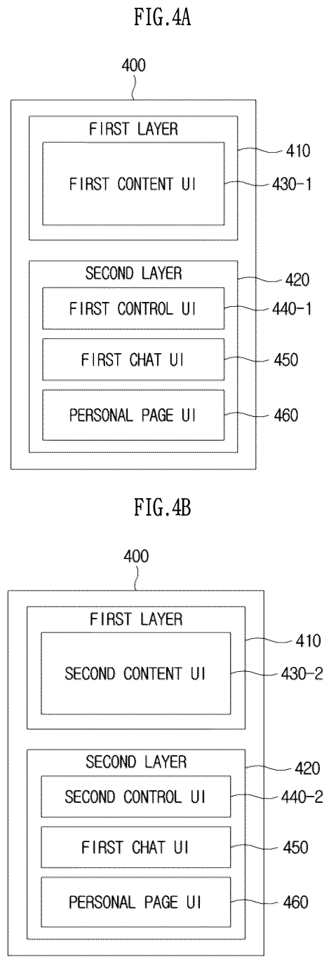

FIG. 3 is a block diagram conceptually showing a first device and/or a second device that dynamically switches the mode of a layer for a two-way communication service, according to an embodiment of the present disclosure. That is, FIG. 3 may be a block diagram of the first device used by the user, but is not limited thereto. FIG. 3 is a block diagram of a second device used by the artist or/and a representative associated with the artist.

The first device/second device 300 may include a processor 310, a transceiver 320, a memory 330, and a user interface 340. The processor 310, transceiver 320, memory 330, display 340, and speaker 350 may exchange data, requests, responses, commands, etc. through an internal communication network.

The processor 310 may control the operations of the transceiver 320, memory 330, display 340, and speaker 350. The processor 310 may perform operations according to the present disclosure. Additionally, the processor 310 may control the overall operation of the first device/second device 300, including components of the first device 300 not shown in FIG. 3.

The transceiver 320 may transmit and receive data with other devices wired or wirelessly.

The memory 330 may store information generated or processed by the processor 310, software related to the operation of the first device and/or the second device 300, an operating system, applications, etc., and may also include components such as buffers. Additionally, the memory 330 may store data according to the present disclosure. Additionally, the memory 330 may include a storage (e.g., hard disk, etc.) that temporarily stores or maintains data.

The display 340 may display a first device/second device 300 an application screen. That is, the display 340 may output various data and/or content.

The speaker 350 may output various audio data. For example, the speaker 350 may output audio data included in content.

The processor 310 may be set to perform operations corresponding to each step of FIGS. 1 and 2, or may include a module that performs each step of FIGS. 1 and 2.

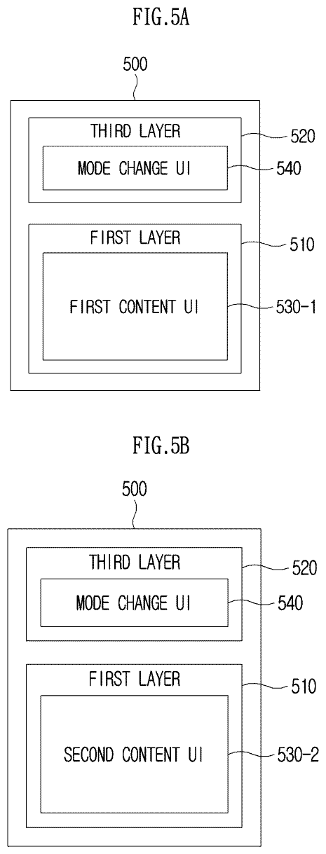

FIG. 4A and FIG. 4B are diagrams for describing a layer structure and conversion procedure according to an embodiment of the present disclosure. Specifically, the layer structure and mode switching procedure displayed on the first device used by the user will be described with reference to FIG. 4A and FIG. 4B.

Application full screen 400 capable of performing the bidirectional communication between one or more artists displayed on a first device controlled by a first user and a plurality of users may include a first layer (or pop core layer) and a second layer (or global chat layer).

Here, the arrangement of the first layer 410 and the second layer 420 may be changed by the first user. The second layer 420 may be disposed to overlap on the first layer 410, or vice versa. Additionally, the size of the first layer 410/second layer 420 and the size of at least one UI included in each layer may be changed by the first user.

The first layer 410 may include a first content UI 430-1 for outputting content related to the mode of the first layer 410 corresponding to the input by the second device. The structure and form of the first content UI 430-1 may change depending on the mode of the first layer 410.

As an example, when the mode of the first layer 410 is the first mode (e.g., live host mode), the first content UI 430-1 may include a UI that can broadcast/output streaming video corresponding to the input of the second device. Here, the live host mode may collectively refer to a mode for communication (e.g., text/voice/video message exchange) between an artist and multiple users and the content associated with the live host mode may include (live) streaming video provided by a second device.

For example, when the mode of the first layer 410 is the second mode (e.g., live participant mode), the first content UI 430-1 may include a UI for exchanging messages between artists and fans.

For example, when the mode of the first layer 410 is the third mode (e.g., star chat mode), the first content UI 430-1 may include a UI that can provide a private message service.

That is, the user can receive at least one of text, image, or video input from the second device (e.g., the artist controlling the second device or/and a representative associated with the artist) through the first content UI 430-1. Accordingly, the user may input a response message or a response image/video for at least one of text, image, or video provided on the first content UI 430-1 through the first device.

In the star chat mode, at least one of the text, image, or video input from the artist through the first content UI 430-1 may be created based on the first user's information (e.g., first user's name, nickname, etc.).

For example, in star chat mode, an artist may input at least one of text, image, or video including at least one identifier through a second device. Here, the identifier included in at least one of text, image, or video input by the second device on the first content UI 430-1 may be replaced with the first user's information. Accordingly, users can feel like they are exchanging private messages with the artist.

The second layer 420 may include a first control UI 440-1 that can control at least one operation related to the mode of the first layer 410.

As an example, the user may extract all or part of the content provided in the first content UI 430-1 of the first layer 410 through the first control UI 440-1. As another example, the user can edit the background screen or structure of the first content UI 430-1 of the first layer 410 through the first control UI 440-1 (e.g., attaching a sticker to the first content UI (430-1), etc.).

As another example, the user may extract at least one content and/or UI element included in the first layer 410 through the first control UI 440-1. The user may input at least one content and/or UI element extracted from the first layer 410 (or/and data that has been edited and processed at least one content and/or UI element) onto the user's personal page UI 460. That is, the user can edit his or her personal page UI 460 through content or/and UI elements on the first layer 410.

More specifically, the second layer 420 may include the user's personal page UJ 460, and the personal page UI 460 may be based on content associated with the mode of the first layer 410.

As an example, the device may generate the second content through all or part of the content extracted from the content provided by the artist in the first content UI 430-1. The device may output the generated second content on the personal page UI 460.

Here, the second content may include, but is not limited to, an edited video or review text/video of all or part of the content provided by the artist in the first content UI 430-1. The second content may collectively refer to all types of content that can be created through all or part of the content provided by the artist in the first content UI 430-1.

As an example of the present disclosure, editing of the personal page UI 460 may be performed based on a reward provided to the user. Rewards may be provided to the user according to the activity history performed by the user in the first layer 410 and/or the second layer 420.

As an example, the user's activity history may include text, images, and videos entered by the user into aaaa, review data of texts, images, and videos entered into the first layer 410 and/or the second layer 420, and artist-related It may include the period of registration for membership, the type/level of membership registered by the user, etc.

As an example, the user's activity history may include a text, image, and video entered by the user into the first layer 410 and/or the second layer 420, review data of text, images, and videos entered into the first layer 410 and/or the second layer 420, the period of registration for membership (i.e., membership to receive content output through the first layer 410 related to the artist) related to the artist, the type/level of membership registered by the user, etc.

Users can use the provided rewards to purchase digital goods (e.g., stickers, emoticons, background music, etc.) related to the artist. The user can edit the personal page UI 460 using purchased digital goods.

As an example, a personal page UI may be implemented in a three-dimensional space. For example, various digital goods and/or avatars representing users may be implemented in 3D form on the personal page UI 460. And, Movement and effects of various digital goods in 3D form and/or avatars representing users can be controlled by the device used by the user on the personal page UI composed of a 3D virtual space (i.e., metaverse-based personal page UI).

Here, changes to the background screen or structure of the first content UI 430-1 can be applied only on the screen displayed on the first device used by the user.

The second layer 420 may include a first chat UI 450 through which a plurality of users can exchange messages with each other. A user in charge of the administrator role may perform a function to force a specific user to leave or warn a specific user or to prohibit an entire chat on the first chat UI 450.

In describing the present disclosure, the administrator may be determined from one of a plurality of users (i.e., a plurality of fans of a particular artist).

However, this is only an example, and the manager may be determined by the company or/and artist that manages the application. A third device used by the administrator may control and manage operations performed at each layer. Here, the third device used by the administrator may include a server, a terminal device connected to the server, and/or a separate device.

As an example, a third device used by the administrator may monitor and detect inappropriate behavior (e.g., writing malicious comments, uploading violence/pornography, etc.) in the first layer 410 and/or the second layer 420. Additionally, a third device used by the administrator may impose sanctions on users who have performed inappropriate actions.

For example, inappropriate behavior in the first layer 410 and/or the second layer 420 may be detected through a separate artificial intelligence model and/or algorithm.

For example, a third device used by the administrator may obtain a text and image input into the first layer 410 and/or the second layer 420 and/or texts and images entered by inputting video into an artificial intelligence model and/or a score indicating inappropriateness corresponding to the video.

Here, the artificial intelligence model may be learned based on input data and training data labeled with a numerical value indicating the degree of inappropriateness of the input data. In other words, the artificial intelligence model may be learned using supervised learning, but is not limited to this.

For example, based on the score indicating inappropriateness corresponding to the input text, image and/or video exceeding the threshold, the third device may delete the input text, image, and/or video from the first layer and/or the second layer 420. Additionally, the third device may suspend the activity rights of the user who uploaded the text, image, and/or video.

As another example, based on the score indicating inappropriateness corresponding to the input text, image and/or video exceeding a threshold, texts, images and/or videos may be transmitted (from the first device and/or server) to the third device. A person in charge using a third device can determine whether to delete the text, image, and/or video.

As an example of the present disclosure, a user may separately create a third chat UI on the second layer 420. The first chat UI 450 includes a UI related to a chat room in which multiple users can participate, and the third chat UI refers to a chat UI created by a user to separately chat on a specific topic.

If an identifier (e.g., artist's ID) corresponding to the second device is added to the participant list on the third chat UI (i.e., user-created chat room) created by the user, a message or/and an indicator indicating participation of the identifier corresponding to the second device (or, an image associated with an artist indicating the participation of an identifier corresponding to a second device, etc.) may be provided in the third chat UI. Accordingly, the user can confirm that the artist has accessed the third chat UI created by the user.

As another example of the present disclosure, the user's level may be determined according to the activity history performed in the first layer 410 and/or the second layer 420.

As an example, the user's activity history may include a text, image, and video entered by the user into the first layer 410 and/or the second layer 420, review data of text, images, and videos entered into the first layer 410 and/or the second layer 420, membership registration period, type of membership registered by the user, etc.

Review data of text, images, and videos entered into the first layer 410 and/or the second layer 420 may include evaluation scores and review text left by the artist and/or multiple users for the text, image, or video.

Identification information representing the user's level may be implemented in the form of a quick response (QR) code or/and non-fungible token (NFT).

As an example, the device used by the user can prove its rating in an online/offline environment through a QR code to which the user's identification information is mapped or/and an NFT issued based on the user's information including the user's rating.

Here, NFT may be issued based on a block corresponding to a hash value indicating the user's level, information, date of joining the artist's fan club, etc. A block may refer to a data storage unit within a block chain code.

For example, a fourth device used by a person in charge of managing an artist's event in an offline environment may recognize/identify the QR code or/and NFT provided from the user's device. The fourth device may check the user's level through QR code or/and NFT.

As an example of the present disclosure, assume that the mode of the first layer 410 is switched from the first mode to the second mode. As shown in FIG. 4(b), the device may switch from the first control UI 440-1 on the second layer 420 to the second control UI 440-2, which can control at least one operation associated with the second mode. Here, the first chat UI 450 and/or personal page UI 460 may be maintained.

Additionally or alternatively, before an artist accesses an application that provides a two-way communication service, only the second layer 420 may be displayed on the application screen running on the device used by the first user. When the artist and/or the person in charge related to the artist accesses the application and determines the mode of the first layer, the entire application screen may be divided into a first layer 410 and a second layer 420 as shown in FIG. 4A or FIG. 4B.

FIG. 5A and FIG. 5B are diagrams for describing a layer structure and conversion procedure according to an embodiment of the present disclosure.

Specifically, the layer structure and mode switching procedure displayed on the second device used by the artist and/or the person in charge related to the artist will be described with reference to FIGS. 5A and FIB. 5B.

As shown in FIG. 5A, the application screen 500 displayed by the second device may include a first layer 510 and a third layer (e.g., top controller layer) 520 for changing the mode of the first layer. As an example, the third layer 520 may be disposed to overlap the first layer 510. That is, the positions of the first layer 510 and the third layer 520 can be freely changed by the artist and/or a person in charge related to the artist.

The third layer 520 may include a mode change UI 540 that can control the mode of the first layer 510 and related functions/options. The second device may select/change the mode of the first layer 510 through the mode change UI 540.

As an example, assume that the second mode is selected as the mode of the first layer 510 by the artist and/or the person in charge related to the artist through the mode change UI 540. As shown in FIG. 5B, the second device may change the mode of the first layer 510 from the first mode to the second mode. As an example, the second device may convert the first content UI 530-1 to the second content UI 530-2 on the first layer 510.

As another example of the present disclosure, the first layer 510 may further include a second chat UI. The text, image, or video input to the second chat UI may be input to the AI model, and a score indicating inappropriateness corresponding to the text, image, or video may be output. Based on the score exceeding a threshold, text, images, or video may be transmitted to a third-party device utilized by the administrator.

Additionally, based on the identifier corresponding to the first user being selected among the plurality of users included in the participant list on the second chat UI, the second device may additionally display a second layer containing the first user's personal page UI.

If an artist using a second device and/or a person in charge related to the artist leaves review data (e.g., ratings and/or comments, etc.) on content output through the first user's personal page UI, a reward may be paid to the first user.

The methods illustrated in the present disclosure are expressed as a series of operations for clarity of explanation, but this is not intended to limit the order in which the steps are performed. If necessary, each step may be performed simultaneously or in a different order. To implement the method according to the present disclosure, other steps may be included in addition to the exemplified steps, some steps may be excluded and the remaining steps may be included, or some steps may be excluded and additional other steps may be included.

The various embodiments of the present disclosure are not intended to list all possible combinations but are intended to illustrate representative aspects of the present disclosure. Matters described in various embodiments may be applied independently or in combination of two or more.

Additionally, various embodiments of the present disclosure may be implemented by hardware, firmware, software, or a combination thereof. For implementation by hardware, it can be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

The scope of the present disclosure includes a software or machine-executable instructions (e.g., operating system, applications, firmware, computer programs, etc.) that cause operations according to the methods of various embodiments to be performed on a device or computer and a non-transitory computer-readable medium in which such software or instructions are stored and executable on a device or computer.

What is claimed is:

1. A method for dynamically switching modes, performed by a first device used by a first user, the method comprising:
displaying a first layer including a first content user interface (UI) based on a first mode and a second layer including a first control UI capable of controlling at least one operation associated with the first mode, the second layer including a first chat UI for exchanging messages with other users;
based on a mode of the first layer switching from the first mode to a second mode, switching from the first control UI to a second control UI capable of controlling at least one operation associated with the second mode on the second layer and maintaining the first chat UI,
wherein a content associated with the mode of the first layer corresponding to an input by a second device is output on the first content UI, and
wherein the second layer includes a personal page UI of the first user based on the content associated with the mode of the first layer.

2. The method of claim 1, wherein:
all or part of the first content associated with the first mode output on the first content UI through the first control UI is extracted, and
a second content generated based on all or part of the extracted first content is output on the personal page UI.

3. The method of claim 1, wherein:
based on a mode of the first layer being a mode for providing streaming video, a content associated with the mode of the first layer includes a live streaming video input to the second device.

4. The method of claim 1, wherein:
based on a mode of the first layer being a mode for private message exchange, a content associated with the mode of the first layer includes at least one of text, image, or video input to the second device, and
at least one of the text, image, or video input to the second device is generated based on information of the first user.

5. The method of claim 1, wherein:
the first layer further includes a second chat UI,
a text, image or video entered into at least one of the first chat UI or the second chat UI on the second layer is input to the artificial intelligence (AI) model and a score indicating inappropriateness corresponding to the text, image or video is output, and
based on the score exceeding a threshold, the text, image, or video is transmitted to a third device used by an administrator.

6. The method of claim 1, wherein:
the second layer includes a third chat UI created by the first user, and
based on an identifier corresponding to the second device being added to a participant list on the third chat UI, at least one of a message or indicator indicating participation of the identifier corresponding to the second device is displayed on the third chat UI.

7. The method of claim 1, wherein:
a rating of the first user is determined based on the first user's activity history in at least one of the first layer or the second layer, and
a non-fungible token (NFT) is generated based on a quick response (QR) code to which identification information indicating the rating of the first user is mapped or information on the first user including the rating of the first user.

8. The method of claim 2, wherein:
the second device is controlled by an artist or an administrator associated with the artist, and
a 3-dimension (3D) avatar representing the first user, digital goods related to the artist, or the second content are included in the personal page UI composed of a 3D virtual space.

9. The method of claim 8, wherein:
the digital goods related to the artist are purchased through rewards based on the first user's activity history in at least one of the first layer or the second layer.

10. A first device performing a method of dynamically switching modes, the first device comprising:
at least one transceiver;
at least one memory; and
at least one processor;
wherein the at least one processor is configured to:
display a first layer including a first content user interface (UI) based on a first mode and a second layer including a first control UI capable of controlling at least one operation associated with the first mode, the second layer including a first chat UI for exchanging messages with other users;
based on a mode of the first layer switching from the first mode to a second mode, switch from the first control UI to a second control UI capable of controlling at least one operation associated with the second mode on the second layer and maintain the first chat UI,
wherein a content associated with the mode of the first layer corresponding to an input by a second device is output on the first content UI, and
wherein the second layer includes a personal page UI of the first user based on the content associated with the mode of the first layer.

11. A method for dynamically switching modes, performed by a second device, the method comprising:
displaying a first layer including a first content user interface (UI) based on a first mode and a third layer for switching a mode of the first layer;
inputting content related to the first mode on the first content UI; and
based on a mode of the first layer being switched from the first mode to a second mode through the third layer, switching from the first content UI to a second content UI for inputting content related to the second mode,
wherein a content associated with the first mode is output on the first content UI displayed on a first device.

12. The method of claim 11, wherein:
the first layer further includes a second chat UI,
a text, image or video input to the second chat UI is input to an artificial intelligence (AI) model and a score indicating inappropriateness corresponding to the text, image or video is output, and
based on the score exceeding a threshold, the text, image, or video is transmitted to a third device used by an administrator.

13. The method of claim 11, wherein:
at least one digital good is generated based on a content associated with the first mode output through the first content UI or a content associated with the second mode output through the second content UI.

14. The method of claim 12, wherein:
based on an identifier corresponding to the first user being selected among a plurality of users included in a participant list on the second chat UI, a second layer including a personal page UI of the first user is displayed.

15. The method of claim 11, wherein:
based on the first mode being a mode for private message exchange, a content associated with the first mode includes at least one of text, image, or video including at least one identifier,
at least one of a text, image, or video including the at least one identifier is output to the first content UI of devices used by a plurality of users, and
the at least one identifier is converted based on information about the plurality of users.
